(19) United States
(12) Patent Application Publication
(10) Pub. No.: US 2005/0198889 A1
(43) Pub. Date: Sep. 15, 2005

(54) Parachute assisted fishing device

(76) Inventors: Kevin Lubinsky, Blackstone, MA (US); Paul W. Lubinsky, Palm Coast, FL (US)

Correspondence Address: Brett N. Dorny, Esq., 321 Church Street, Northborough, MA, 01532, US

(21) Appl. No.: 10/798,832

(22) Filed: Mar. 11, 2004

(51) Int. Cl. A01K 85/00

(52) U.S. Cl. 43/42.02; 43/17.2; 43/42.11

(57) ABSTRACT

The fishing device of the present invention provides a parachute on the fishing line for use with large game fish. The parachute is enclosed in a container and released upon hooking a fish. The parachute provides a drag for the fish. The drag slows the fish and tires it more quickly. The slower speeds of the fish caused by the drag help prevent loss of the fish due to line breakage, hook release, or lack of line. The fishing device may also function as a lure.

### BACKGROUND OF THE INVENTION

1. Field of the Invention

The present invention relates to fishing equipment. More particularly, it relates to a parachute assisted fishing device for large game fish.

2. Discussion of Related Art

There are many difficulties involved in catching large game fish, such as such as bluefin and bigeye tuna, marlin, swordfish, or shark. When fishing for large game fish, anglers typically employ multiple rods that rest in rod holders. When a fish is hooked on a particular rod, the angler removes that rod from the holder and makes his way into a fighting chair to assist in the capture of the fish. These fighting chairs are well known in the art. Typical fighting chairs provide the angler with a place to sit while reeling in the hooked fish. They also provide support for the rod and reel. To bring in a large hooked fish, anglers cannot usually simply reel in the fish. The weight and strength of the fish cannot be overcome by the cranking arm on the reel. Furthermore, the fishing line typically is not strong enough to hold the fish if it makes a sudden dart away from the direction of the pole.

In order to capture a hooked fish, anglers use a combination of several motions to slowly bring the fish towards the boat. The angler pulls the rod toward his body so that it pivots about the butt of the rod. This motion moves the fish towards the boat. The angler then reverses the motion by quickly lowering the tip of the rod and reels in the slack in the line. This motion requires a great deal of strength to pull in a large fish. It becomes easier as the fish tires, but the angler also tires over time.

In order to prevent line breakage, the reel that holds the line is fitted with a friction drag. Any pull on the line greater than the set amount causes the reel to play out line. When a fish darts quickly away from the boat, the drag is exceeded and the line plays out. The line may also play out simply from a large, strong fish swimming in the opposite direction. As line plays out, the angler has to continue the process to reel in all of the line which has gone out. Additionally, if all of the line on the reel plays out, the line will break and the fish is lost. Many large fish keep away from the fishing boats. In order to catch them, lots of line must be let out before the fish is hooked. A strong fish may be able to pull the rest of the line out.

Other problems may result in losing a hooked fish. Often a fish will jump out of the water. The stresses on the line and hook change as the fish leaves the water. These changes may allow the hook to come lose and the fish to escape. Also, a fish can change direction fairly quickly. When a fish changes direction, the line bows forming an arc behind the fish. The arc of line is pulled sideways through the water. The stresses created by this movement can exceed the strength of the line causes the line to break.

### SUMMARY OF THE INVENTION

The fishing device of the present invention avoids many problems involved with large game fishing by connecting a parachute to the fishing line near the fish. According to one aspect of the invention, the parachute is enclosed in a container until after a fish is hooked. The container then opens and the parachute is engaged. The parachute provides additional resistance to the fish swimming to limit its speed and tire it more quickly. The lower speed of the fish reduces the changes of a break in a bowed line. The parachute further limits the ability of the fish to break the surface and the associated dislodging of the hook. According to an aspect of the invention, the parachute is unidirectional. It provides resistance to the fish swimming, but not to the line being pulled in by the angler.

According to one aspect of the invention, the container is positioned near the hook and is designed to function as a lure. According to another aspect of the invention, the container is positioned in the line away from the hook. According to one aspect of the invention, the line passes through the parachute. According to another aspect of the invention, the line does not pass through the parachute, but the top of the parachute is tethered to the line. According to another aspect of the invention, the parachute is packed within the container to allow easy deployment and to prevent tangles in the line and the parachute. According to another aspect of the invention, the parachute includes swivels to allow rotation of the parachute about the line. According to another aspect of the invention, the parachute includes a design to limit rotation of the parachute as it passes through the water.

### BRIEF DESCRIPTION OF THE DRAWINGS

FIG. 1 is a front view of a fishing device in a closed position according to a first embodiment of the present invention.

FIG. 2 is a front view of a fishing device in an open position according to a first embodiment of the present invention.

FIG. 3 is an interior view of a fishing device in a closed position according to a first embodiment of the present invention.

FIG. 4 is a front view of a parachute attachment swivel according to an embodiment of the present invention.

FIG. 5 is a front view of a fishing device in an open position according to a second embodiment of the present invention.

FIG. 6 is a front view of a fishing device in a closed position according to a third embodiment of the present invention.

### DETAILED DESCRIPTION

The present invention provides a parachute along a fishing line. The parachute provides a drag on the fish. This drag slows the fish down and tires it more quickly. The slower speed of the fish limits many of the problems involved in fishing for large game fish. The fish cannot pull out the line as fast. Thus, the line is less likely to run out. When the line bows, the slower speed reduces the stresses on the line to limit breakage. The slower fish speed also prevents the fish from leaving the water, which limits the chances for the hook to come loose. These advantages improve the chances of landing a fish once hooked.

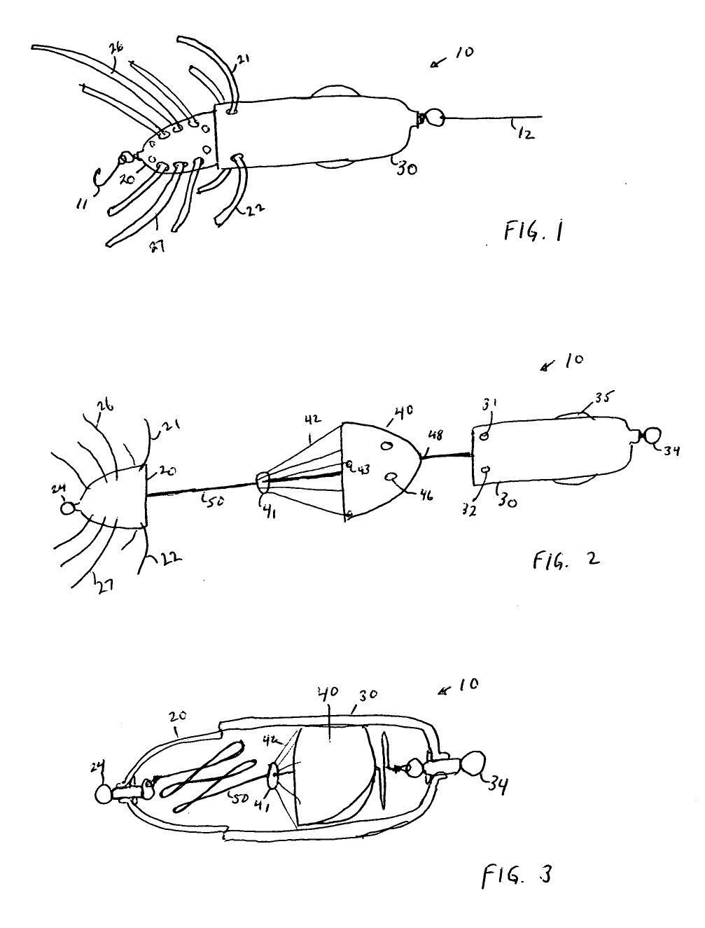

A fishing device 10 according to a first embodiment of the present invention is illustrated in closed and open positions, in FIGS. 1 and 2, respectfully. The fishing device 10 includes a container having two parts 20, 30. The two parts 20, 30 of the container 10 are connected together in the closed position so that a desired level of force is necessary to separate the two parts. According to an embodiment of the invention, the connection is made by passing cords 21, 22 in one part 20 of the container through holes 31, 32 in the other part 30 of the container. The cords 21, 22 are sized to create friction within the holes 31, 32. Thus, a force is necessary to overcome the friction and allow the two parts 20, 30 of the container to separate. The amount of force required to separate the parts depends upon the relative sizes of the cords and holes and upon the number of them. The amount of force should be such that the drag of the hook and bait through the water will not open the container, but that the forces caused by the fish pulling against the line will.

Rings 24, 34 are positioned on opposite ends of the two parts 20, 30 of the container. One ring 24 is attached to the hook 11. The other ring 34 is attached to the fishing line 12. A line 50 extends within the container between the rings 24, 30. A parachute 40 is connected to the line 50. According to an embodiment of the invention, the line 50 is formed of twisted wire cable having a test strength of 800 lbs. The parachute 40 is formed of rip-stop nylon and treated so as to not be permeable. Alternatively, the parachute 40 may be formed of spiderwire. According to an embodiment of the invention, the parachute 40 is 14 inches in diameter. A parachute of this size sufficiently slows most large game fish. According to another embodiment, the parachute 40 has a diameter of 24 inches.

As illustrated in FIG. 2, the parachute is domed in the direction of the fishing line 12. In this manner, when the line 12 is pulled in, the parachute 40 collapses and moves easily through the water. When the fish pulls the line 12, the parachute 40 catches water and provides drag to the fish. The amount of drag depends, to some degree, on the speed of the fish. As the speed of the fish increases, so does the drag. However, at a certain speed, the amount of drag levels off. The speed at which the drag levels off depends upon the dimensions of the parachute.

The outer edge of the parachute 40 is connected by suspension lines 42 to a swivel 41. The suspension lines 42 may be directly attached to the parachute or connected to grommets, loops or other connectors. The suspension lines 42 may be formed of fishing line or spiderwire. Five suspension lines of 20 lb test is sufficient to support the parachute 40 in connection with the speeds of most large game fish. The swivel 41 allows the parachute to rotate without tangling the suspension lines 42 or the line 50. In the first embodiment of the invention illustrated in FIG. 2, the line 50 passes through the top of the parachute 40. A swivel 48 in the top of the parachute 40 is attached to the line 50. The swivel 48 keeps the parachute 40 properly positioned on the line 50.

As the parachute 40 is pulled through the water, it tends to rotate. Holes 46 can be placed near the top of the parachute. The use of three holes limits the rotation of the parachute 40 without significantly limiting the drag of the chute.

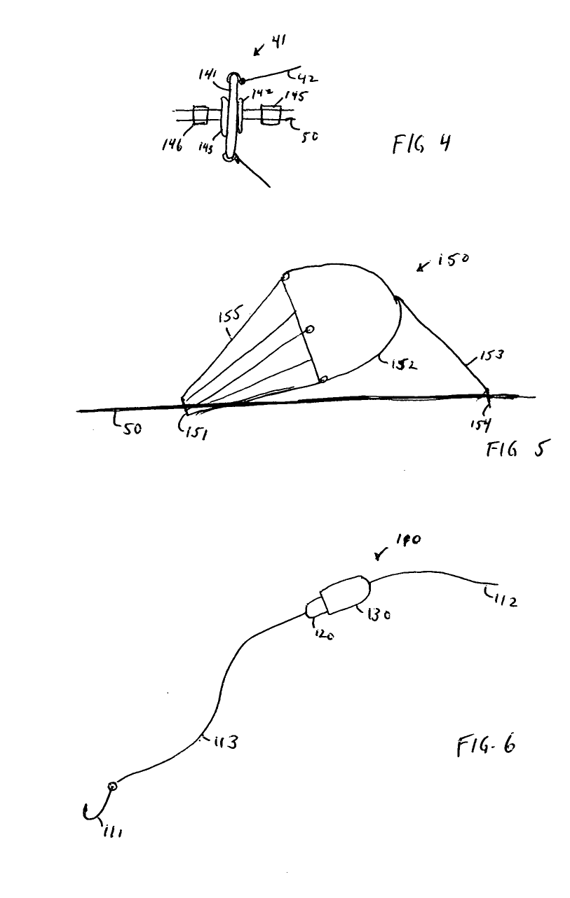

FIG. 4 illustrates an embodiment for attaching the swivel 41 to the line 50. The swivel 41 is formed of a flat metal disk 141. The disk 141 has a hole (not shown) in the center through which the line 50 passes. The hole is large enough that the disk 141 can move freely on the line 50. Additional holes are positioned around the periphery of the disk 141. The suspension lines 42 connect to these additional holes. The number of holes corresponds to the number of suspension lines 42. Two additional disks 142, 143 are positioned on either side of the first disk 141. These disks also have holes through the middle sized to accommodate the line 50. Metal bands 145, 146 are attached to the line 50 on either side of the three disks 141, 142, 143. The bands 145, 146 limit movement of the disks along the line. A similar structure can be used for the swivel 48 at the top of the parachute 40.

FIG. 3 is an interior view of the fishing device in the closed position. The line 50 is coiled within the container. As illustrated in FIG. 3, the line 50 is coiled in a figure 8 pattern. The number of loops in the line 50 depends upon the length of the wire and the size of the container. Using the figure 8 pattern allows the line to unwind without tangling or kinking. The parachute 40 is trash packed in one of the parts 30 of the container. The rings 24, 34 are connected to swivels within the container. The ends of the line 50 connect to the other side of the swivels.

The container may be formed to function as a lure. As illustrated in FIGS. 1 and 2, the container is shaped to appear as a squid. The cords 21, 22 form a part of the image. Additional cords 26, 27 are placed in holes within a part 20 of the container to add to the image. The other part 30 of the container may include details 35 to provide the desired appearance.

A second attachment mechanism 150 for the parachute 152 is illustrated in FIG. 5. The parachute 152 is of similar size, shape and material to that of the first embodiment. Suspension lines 155 of fishing line or spiderwire connect the periphery of the parachute 152 to a swivel 151. The swivel 151 is attached to the line 50 in the same manner as for the first embodiment as illustrated in FIG. 4. In the second embodiment, the line 50 does not pass through the parachute 152. Instead, the parachute 152 moves separately from the line 50. In order to keep the parachute properly positioned to provide drag for the fish but not for the angler, the top of the parachute 152 is tethered to the line 50. A tether line 153 connects the top of the parachute 152 to the line 50. The tether 153 is long enough to allow the parachute 152 to fully open without interference from the line. Swivels 154, 155 are used to connect both ends of the tether. The swivels 154, 155 allow the parachute 152 to freely rotate about the line 50.

Another embodiment of the fishing device 110 of the present invention is illustrated in FIG. 6. In this embodiment, the container does not function as a lure. As in the first embodiment, the container includes two parts 120, 130. The fishing device 110 includes a parachute within the container as in the first embodiment. One part 130 of the container is connected to the fishing line 112 which goes to the rod and reel. The other part 130 of the container attaches to a length of line 113. The length of line 113 attaches to the hook 111. The length of line 113 is approximately 8 to 10 feet long. In this embodiment, bait is used on the hook. As in the first embodiment, when the fish is hooked, the two parts 120, 130 of the container open to release the parachute.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A fishing device comprising:
a line connectable between a fishing line and a hook; and
a parachute having a periphery, the periphery being attached to the line so as to provide a drag when the line is pulled in the direction of the hook.

2. (canceled)

3. The fishing device of claim 1, wherein the parachute is attached to the line so as to not provide a drag when the line is pulled in the direction of the fishing line.

4. The fishing device of claim 1, wherein the line passes through at least a portion of the parachute.

5. The fishing device of claim 1, wherein the parachute includes:
a plurality of suspension lines, each having a first end and a second end, the first ends of the plurality of suspension lines being connected at spaced locations near the periphery of the parachute; and
a first connector attached to the second ends of the plurality of suspension lines, wherein the first connector is attached to a first point on the line.

6. The fishing device of claim 5, wherein the first connector can rotate about the line.

7. The fishing device of claim 5, wherein the parachute further includes:
a tether line having a first end and a second end, the first end being connected to a central portion of the parachute; and
a second connector attached to the second end of the tether line, wherein the second connector is attached to a second point on the line, the second point being spaced from the first point.

8. The fishing device of claim 1, further comprising:
a container having two parts, wherein one part is connected to the fishing line and one part is connected to the hook;
wherein the line and the parachute can be packed within the container.

9. The fishing device of claim 8, wherein the container further includes a connector for attaching the two parts with the line and parachute packed within the container.

10. The fishing device of claim 9, wherein the connector releases the two parts when a tension between the hook and the fishing line exceeds a threshold.

11. The fishing device of claim 9, wherein the connector includes:
a plurality of cords attached to one of the two parts; and
a plurality of holes in the other of the two parts for receiving the plurality of cords.

12. The fishing device of claim 8, wherein the container is shaped to function as a lure.

13. The fishing device of claim 1, wherein the parachute is located near the hook.

14. The fishing device of claim 1, wherein the parachute is spaced away from the hook.

15. A method of providing resistance to a swimming fish when fishing, the method comprising the steps of:
engaging a hook in a fish, the hook being attached to a fishing line;
deploying a parachute connected to the fishing line when the hook is engaged to create a drag to the fishing line in the water.

16. (canceled)

17. The method of claim 15, wherein the step of deploying the parachute includes the steps of:
providing a drag from the parachute when the hook is moved in a direction away from the fishing line; and
releasing the drag from the parachute when the hook is moved in a direction towards the fishing line.

18. (canceled)
